(19) United States
(12) Patent Application Publication
(10) Pub. No.: US 2003/0091171 A1
(43) Pub. Date: May 15, 2003

(54) Method for supporting the charging of services

(75) Inventors: Rodolfo Lopez Aladros, Stuttgart (DE); Franz-Josef Banet, Vaihingen (DE); Matthias Duspiva, Leonberg (DE); Wolfgang Lautenschlager, Weissach-Flacht (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/291,635

(22) Filed: Nov. 12, 2002

(30) Foreign Application Priority Data
Nov. 13, 2001 (EP) 01 440 381.0

(51) Int. Cl. H04M 15/00

(52) U.S. Cl. 379/114.03; 379/114.05; 379/114.28; 379/121.01

(57) ABSTRACT

The invention relates to a method for supporting the charging of services in a communications network, and to a server, a computer program and a storage medium with a computer program for executing the method. Charging data relating to the charging of a service used by a user of the communications network is generated by a network element or a service server of the communications network. For the purpose of storing the generated charging data, the network element or the service server contacts a central memory service for several network elements and/or service servers. The central memory service stores the charging data in a charging data record, managed by it, which is assigned to the user of the communications network and is suitable for containing charging data relating to the use of two or more different types of services. For the purpose of accessing charging data of the user, a charging server contacts the central memory service which then enables the charging server to read out data from the charging data record of the user managed by the central memory service.

### TECHNICAL FIELD

The invention relates to a method for supporting the charging of services in a communications network in which charging data relating to the charging of a service used by a user of the communications network is generated by a network node or a service server of the communications network. The invention further relates to a server for executing the method.

The invention is based on a priority application EP 01 440381.0, which is hereby incorporated by reference.

### BACKGROUND OF THE INVENTION

The invention proceeds from the usual method for charging of telephone services in a telephone network. The charging data for the use of services by a user of the telephone network is generated by the local switching centre assigned to this user and stored in this local switching centre. In this case, the charging data is generated by the local switching centre from the connection data of the respective user. The charging data present in the local switching centre thus relates only to the service “provision of a communication connection”. For the purpose of compiling a bill, a charge server requests from the local switching centres the charging data stored by the latter. This charging data, however, as explained above, relates only to the charging of the connection service. To render possible the compilation of a complete bill, the charging server therefore additionally requests charging data from further servers of the telephone network. Thus, for example, from the service server which provides the “short message service”, it requests charging data relating to the use of this service. From the thus collected charging data, the charging server then calculates the bill for the user of the telephone network.

### SUMMARY OF THE INVENTION

The object of the invention is to provide for an economical and effective provision and processing of charging data within a communications network.

This object is achieved by a method for supporting the charging of services in a communications network, charging data relating to the charging of a service used by a user of the communications network being generated in the method by a network element or a service server of the communications network, wherein, for the purpose of storing the generated charging data, the network element or the service server contacts a central memory service for several network elements and/or service servers, wherein the central memory service stores the charging data in a charging data record, managed by it, which is assigned to the user of the communications network and is suitable for containing charging data relating to the use of two or more different types of services, and wherein, for the purpose of accessing charging data of the user, a charging server contacts the central memory service which then enables the charging server to read out data from the charging data record of the user managed by the central memory service. This object is further achieved by a server for supporting the charging of services in a communications network, with a control unit and with interfaces for connecting to network elements and/or service servers of the communications network, wherein the control unit is designed in such a way that it provides for several network elements and/or service servers a central memory service which manages charging data records of a multiplicity of users of the communications network which are respectively suitable for containing the charging data relating to the use of two or more different types of services of the communications network, wherein the control unit is further designed in such a way that, when the central memory service is contacted by a network element or a service server of the communications network for the storage of charging data generated by this network element or service server and relating to the charging of a service used by a user of the communications network, it stores the charging data in that record of the charging data records which is assigned to that user, and wherein the control unit is further designed in such a way that, when the central memory service is contacted by a charging server for access to charging data of the user, it enables the charging server to read out data from the charging data record of that user.

The invention in this case is based on the concept of introducing into the communications network a central memory service, for several network nodes and/or service servers, which is contacted by the network nodes and/or the service servers for the purpose of storing the generated charging data and thus centrally stores the charging data for the use of two or more different types of services. This object is further achieved by computer program for supporting the charging of services in a communications network, wherein the computer program is designed in such a way that, in its execution on a system platform, it provides for several network elements and/or service servers a central memory service which manages charging data records of a multiplicity of users of the communications network which are respectively suitable for containing the charging data relating to the use of two or more different types of services of the communications network, wherein the provided central memory service , when it is contacted by a network element or a service server of the communications network for the storage of charging data generated by this network element or service server and relating to the charging of a service used by a user of the communications network , stores the charging data in that record of the charging data records which is assigned to that user, and wherein the provided central memory service, when it is contacted by a charging server for access to charging data of the user, enables the charging server to read out data from the charging data record of that user.

The invention has the advantage that it renders possible the immediate compilation of a bill which includes a multiplicity of services. Such immediate, i.e., temporally current, billing is required particularly in the “prepaid user” sector. A further advantage results from the fact that this charging of new services by means of the invention can be integrated into an existing system in a simple and economical manner.

Further advantages result from the fact that the interface between network nodes, service servers and charging servers is simplified. This enables new charging services and billing data to be introduced in a rapid, simple and economical manner. A further advantage of the invention is that the structure and manner of functioning of the network nodes, service servers and charging servers are simplified through the introduction of this central memory service. On the one hand, network nodes and service servers are freed from functions relating to data security, back-up solutions and the storage of charging data. On the other hand, charging servers no longer need functions which relate to the collection of charging data of a multiplicity of network nodes and service servers which use different communication protocols and data formats. As a result, the development expenditure is greatly reduced.

Advantageous developments of the invention are disclosed in the sub-claims.

### BRIEF DESCRIPTION OF THE DRAWINGS

The invention is explained exemplarily in the following with reference to several embodiment examples and with the aid of the accompanying drawings.

FIG. 1 shows a block diagram of a communications network with a server according to the invention.

FIG. 2 shows a functional representation of the server according to the invention shown in FIG. 1 and of a network node and of a charging server of the communications network shown in FIG. 1.

### BEST MODE FOR CARRYING OUT THE INVENTION

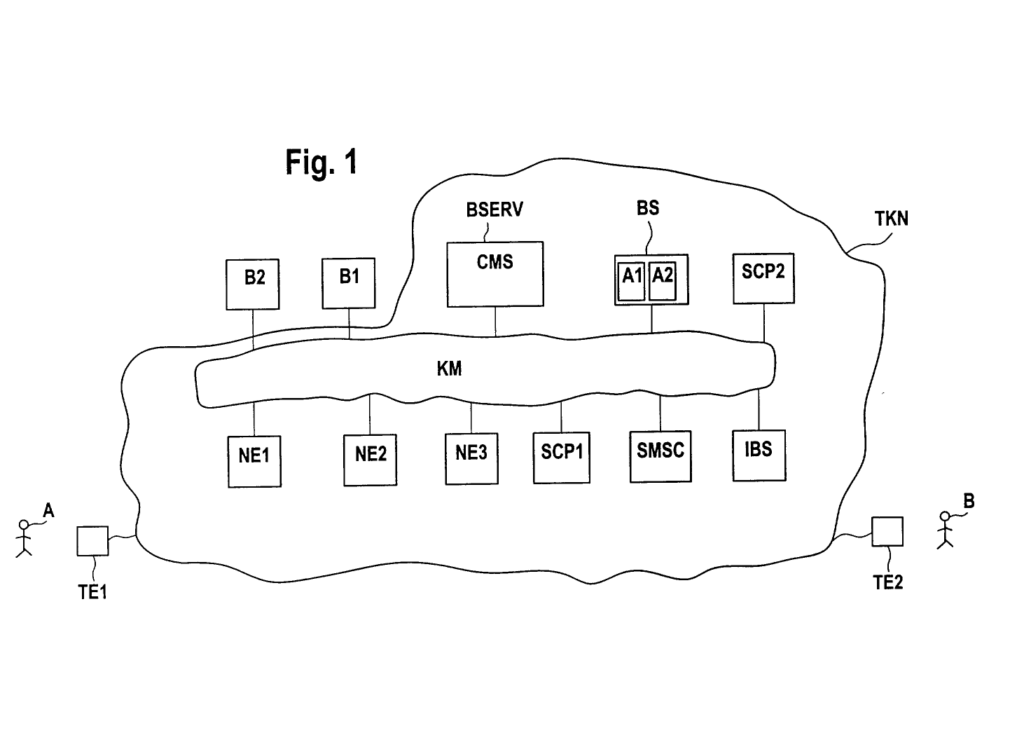

FIG. 1 shows a communications network TKN which is connected to two terminals T1 and T2. The terminals T1 and T2 are respectively assigned to a user A and a user B. The communications network TKN comprises a communications medium KM, several network elements NE1 to NE3, several service servers SCP1, SMSC and IBS, two charging servers BS and SCP2 and a server BSERV.

Additionally shown in FIG. 1 are two charging servers B1 and B2 which are not part of the communications network TKN. The network nodes NE1 to NE3, the service servers SCP1, SMSC, IBS and the charging servers B1, B2, BS and SCP2 are connected to the server BSERV via the communications medium KM.

The communications network TKN is a telephone network, for example, in this case an ISDN network (ISDN=Integrated Service Digital Network). This telephone network can also consist of several sub-networks, which are different fixed-line networks or mobile telephony networks, for example, operating according to the GSM standard or the UMTS standard (GSM=Global System for Mobile Communication, UMTS=Universal Mobile Telecommunications System). It is also possible for different sub-networks to be assigned to different network operators. Furthermore, it is also possible for the telecommunications network TKN to be a data network or a telecommunications network by means of which data, speech and/or image information can be exchanged between terminals.

The telecommunications network TKN can also be a data network which provides as a service the transmission of data by means of the TCP/IP protocols (TCP=Transmission Control Protocol, IP=Internet Protocol).

Within the communications network TKN, the users, of whom the users A and B are shown as examples in FIG. 1, are provided with services of different types. Such a service is the communication service, which provides as a service the establishment of communication to two or more terminals of users of the communications network. Further services consist in the transmission of particular information, the filtering of particular information from a large data stock, the sale of goods or services, or the storage or processing of information transmitted to the service.

The terminals T1 and TE2 are telephone terminals, for example, an ISDN terminal and a mobile telephony terminal operating according to the GSM standard. It is of course also possible for the terminals T1 and TE2 to be terminals of a different type which can be connected to the communications network TKN. Thus, for example, the terminals T1 and TE2 can be computers with a modem card or LAN card (LAN=Local Area Network).

The network nodes NE1 to NE3 are local switching centres of the communications network TKN. However, the network nodes NE1 to NE3 can also be network nodes of the communications network KN1 which are of a different type, the scope of their functions including the generation of charging data. Such network elements can be, for example, purchase or manager elements of data networks.

The service server SCP1 is an IN service server (IN=Intelligent Network). This service server provides an IN service within the communications network KN. The service server SMSC is a service server of the communications network TKN which provides users of the communications network TKN with the so-called “short message service”. This service transmits short messages between users of the communications network TKN. The service server IBS is a server of the communications network TKN which processes the charging of Internet services which are used by users of the communications network TKN.

It is of course also possible for other, or different types of, service servers of the communications network TKN to generate charging data and to be connected to the server BSERV via the communications medium KM.

The charging server BS is the billing computer of the communications network KN. It is also frequently termed a “billing center” or “customer care and billing center”. The charging server BS has several charging applications, of which the applications A1 and A2 are shown as examples in FIG. 1. The applications A1 and A2 respectively render a special charging function and, for the execution of this respective function, require access to charging data. The charging server SCP2 is an IN service server. This IN service server provides, for users of the communications network TKN, a service for the provision of which it requires access to charging data. Such a service can consist, for example, in the display of charging information or in the management of a pre-paid account. Since the IN service server thus requires charging data as input data for the provision of its function, it constitutes a charging server. The charging servers B1 and B2 are servers of banks or credit institutions. These servers also require access to charging data of the communications network TKN for the provision of their function, and in this sense constitute charging servers.

It is also possible for other, or different types of, servers which require charging data of the communications network TKN as input data, and thus constitute charging servers, to be connected to the server BSERV via the communications medium KM.

The server BSERV consists of a computer or of several computers connected via a communications medium, and of a software platform of application programs running on these computers. A memory service CMS, described in detail below, is provided in the execution of these application programs on the system platform, consisting of a hardware and software platform, of the server BSERV. It is also possible for the server BSERV to be a virtual server whose hardware and software components are distributed over several servers which substantially provide other functions. It is also possible for the application programs of the server BSERV to run on the system platform of one of the network elements NE1 to NE3, one of the service servers SCP1, SMSC, IBS or one of the charging servers BS or SCP2, and for these servers then respectively to provide the function of the server BSERV.

The memory service CMS provided by the server BSERV is a central memory service which manages charging data records of a multiplicity of users of the communications network TKN. These charging data records are respectively suitable for containing the charging data relating to the use of two or more different types of services of the communications network. If the memory service CMS is contacted by one of the network nodes NE1 to NE3 or one of the service servers SCP1, SMSC or IBS for the storage of charging data, generated by this network node or service server and relating to the charging of a service used by a user of the communications network, it stores the charging data in those charging data records that are assigned to this user. If the central memory service CMS is contacted by one of the charging servers B1, B2, BS or SCP2 for access to charging data of a user, the memory service enables data to be read out from the charging data record of that user.

The communications medium KM enables the memory service CMS to be contacted by the network elements NE1 to NE3, the service servers SCP1, SMSC, IBS and the charging servers B1, B2, BS and SCP2. The communications medium KM is preferably a data network via which the above-mentioned components communicate. It is also possible, however, for two or more of these components to run on the same system platform and for the communications medium KM thus also to comprise communication functions of this common system platform. The communications medium KM also advantageously comprises a framework which enables the memory service CMS to be accessed in a simple manner. For example, the memory service CMS could be provided via a so-called software bus. The components can be connected to one another via, for example, a CORBA platform (CORBA=Common Object Request Broker Architecture). Furthermore, SAN technology can be used for accessing the memory service CMS (SAN=Storage Area Networks).

The user A uses a service of the telecommunications network TKN via his terminal T1. In this embodiment example, this service consists in the establishment of a telephone connection to the terminal TE2 of the user B. The network element NE1 constitutes the local switching centre of the user A. As soon as the telephone connection to the user B is terminated, the network element NE1 generates, from the connection data available to it, charging data relating to the charging of the service used by the user A, i.e., the provision of the telephone connection between the user A and the user B. This charging data contains, for example, the number of the destination user and end user of the connection, and the duration of the connection. For the purpose of storing the charging data in memory, the network node NE1, via the communications medium KM, contacts a central memory service for several network nodes and/or service servers of the communications network TKN. Such a central memory service in this case has the characteristic of centrally storing charging data of several network nodes and/or service servers. The memory service CMS is such a central memory service and the memory service CMS is thus contacted by the network node NE1.

It is advantageous in this case for the network node NE1 to contact the central memory service CMS immediately following generation of the charging data for storage of the charging data. Immediately in this connection means that the contacting of the memory service CMS is initiated by the generation of the charging data and is effected a short time after this generation.

It is furthermore advantageous for the network node NE1 to contact a memory service which manages a charging data record in which the charging data of all services of the communications network used by the user A are centrally stored. The network node NE1 thus selects that central memory service which centrally manages the charging data of that user who has used the service for which it has generated the charging data.

The central memory-stock service CMS stores the charging data, on account of which it has been contacted by the network node NE1, in a charging data record managed by it. This charging data record is a charging data record, assigned to the user A of the communications network, which is suitable for containing charging data relating to the use of two or more different types of services.

For the purpose of compiling the bill for the user A, the charging server BS requires charging data of the user A. To access these charging data of the user A, the charging server BS contacts the central memory service CMS.

It is advantageous in this case for the charging server BS to contact that central memory service which manages a charging data record in which the charging data of all services of the communications network used by the user A are centrally stored.

If the central memory service CMS is contacted by a charging server for the purpose of accessing charging data of a user of the communications network TKN, it enables the charging server to read out data from the charging data record, for that user, managed by the central memory service. The memory service CMS thus enables the charging server BS to read out data from the charging record of the user A that is managed by the memory service.

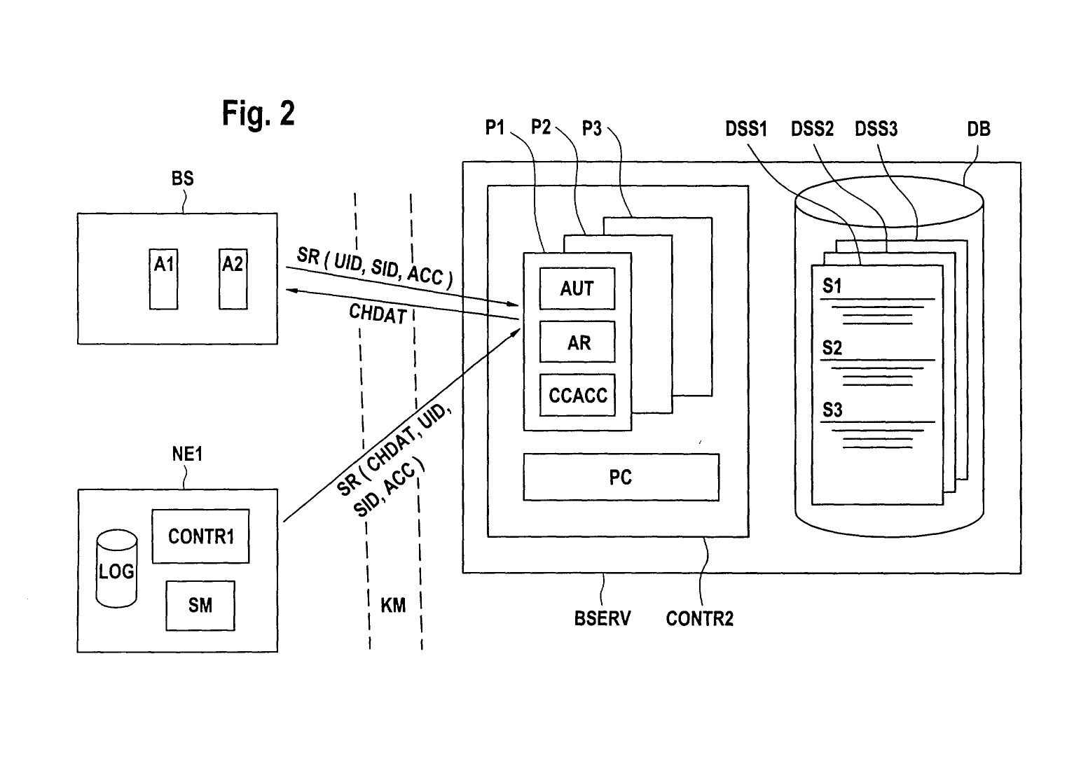

Details of the structure and functioning of the server BSERV are described in the following with reference to FIG. 2.

FIG. 2 shows the server BSERV, the charging server BS and the network node NE1. The network node NE1 has a control unit CONTR1, a switching network SM and a memory unit LOG. The control unit CONTR1 controls the functions of the network node NE1 and is formed by a computer and by the software running on this computer. The memory unit LOG is a databank. The memory unit LOG could also be omitted.

The charging server BS consists of a computer and the software running on this computer. The charging server has the applications A1 and A2. As already explained above, the applications A1 and A2 require charging data of the communications network TKN in order to provide their respective functions.

The server BSERV supports the charging of services of the communications network TKN. It has interfaces for connecting to network nodes and/or service servers of the communications network TKN. The server BSERV thus has an interface to the communications medium KM, via which interface the server BSERV is connected to the network nodes NE1 to NE3, the service servers SCP1, SMSC, IBS and the charging servers B1, B2, BS and SCP2. The server BSERV has a control unit CONTR2 and a memory unit DB.

It is also possible for the memory unit DB not to be part of the server BSERV. The memory unit DB can also be part of another server or several other servers which are connected to the server BSERV via a communications network.

The memory unit DB is formed by, for example, a databank. It has a multiplicity of charging data records, of which the charging data records DSS1, DSS2 and DSS3 are shown as examples in FIG. 2. Each of the charging data records DSS1 to DSS3 is assigned to one of the users of the communications network TKN. Thus, for example, the charging data record DSS1 is assigned to the user A. The charging data records DSS1 to DSS3 are respectively modelled in such a way that they can contain the charging data relating to the use of two or more different types of services of the communications network. Thus, for example, the charging data record DSS1 contains charging data for three different types of services S1, S2 and S3 of the communications network TKN. Within the charging data record DSS1, the charging data which relate to the use of the service S1 by the user A are assigned to a first sub-data-record, those which relate to the use of the service S2 by the user A are assigned to a second sub-data-record and those which relate to the use of the service S3 by the user A are assigned to a third sub-data-record. It is of course also possible for the data to be differently structured within the charging data record DSS1. For example, each element of the charging data record DSS1 could contain, as parameters, the type of the service used (for example, S1 to S3), the time of the use of the service, the duration of use of the service, identification of the user who has used the service and further data, for example, the applicable tariff schedule, authorization code, calling and called user (in the case of a communications service), priority classes or charge amount. It is also possible in this case for the parameters to be available in dependence on the type of service.

It is also possible for the charging data records DSS to DSS3 not to form a coherent data record in each case, but to be respectively formed from a concatenated list of data elements or to result from data elements with the same user identification.

The control unit CONTR2 is formed from a computer of from several computers connected via a communications medium, and from a software platform running on these computers and application programs running on this software platform. The application programs in this case are formed in such a way that, in their execution on the above-mentioned software and hardware platforms of the control unit CONTR2, they bring about the functions of the control unit CONTR2 which are described in the following:

The control unit CONTR2 provides a central memory service, namely, the memory service CMS, for several network nodes and/or service servers. This memory service manages the charging data records of a multiplicity of users of the communications network TKN, these charging data records being respectively suitable for containing the charging data relating to the use of two or more different types of services of the communications network. The central memory service provided by the control unit CONTR2 thus manages, for example, the data stored in the memory unit DB. As port of the management of these charging data records, it controls the storage of data into, and reading of data from, the memory unit DB. If the memory service provided by the control unit CONTR2 is contacted by a network node or a service server of the communications network TKN for the storage of charging data generated by this network node or service server and relating to the charging of a service used by a user of the communications network, the control unit CONTR2 stores this charge in that record of the charging data records which is assigned to that user. If the central memory service provided by the control unit CONTR2 is further contacted by a charging server for access to charging data of a user of the communications network TKN, the control unit CONTR2 enables this charging server to read out data from the charging data record of that user.

A possible program-based method of realizing the provision of the functions outlined above is described in the following:

In respect of function, the control unit CONTR2 has four software-implemented functions AUT, AR, CCACC and PC. The function PC manages processes, of which three processes P1, P2 and P3 are shown as examples in FIG. 2. The processes managed by the function PC can also run in parallel in this case. As part of the processes P1, P2 and P3, the functions AUT, AR and CCACC are executed in each case.

The function PC recognizes when the central memory service provided by the control unit CONTR2 is contacted by a network node, by a service server or by a charging server. In this case, the central memory service is contacted, for example, through the transmission of a service request to this memory service. The addressing of the memory service can be effected in this case through an object address, a file address or through the designation of a special assigned function identification in the central memory service. For the purpose of contacting the central memory service, for example, the control unit CONTR1 thus directs a service request SR, with parameters CHDAT, UID, SID and ACC, to the central memory service. For the purpose of contacting the central memory service, the application A2 directs a service request, with parameters UID, SID and ACC, to the central memory service via the communications medium KM.

If the function PC recognizes that the central memory service is contacted, for example, if it recognizes the receipt of a service request directed to the central memory service, it generates a process, for example, the process P1. This process then processes the service request. When the processing of the service request is completed, the assigned process, for example, the process P1, is terminated by the function PC.

The function AUT determines the identity of the network element, service server or charging server contacting the central memory service. It then passes the determined identity to the function AR. The determination of the identity of the contacting network element, service server or charging server can be effected by means of the parameters contained in a service request. The identity can be determined, for example, from a parameter which indicates the identification of the object or process sending the service request. Furthermore, a special identification can be agreed between network elements, service servers and charging servers on the one hand and the server BSERV on the other hand. This identification can then be passed over upon the contacting of the central memory service by the contacting network element, service server or charging server. It is advantageous in this case for the function AUT to access a special conversion databank in the determination of the identity.

It is furthermore advantageous for the function AUT additionally to verify, by means of an authentication procedure, the identity of the network element, service server or charging server contacting the central memory service. Such an authentication procedure can be realized in the verification of an authentication code which is passed over at the same time as the contacting, or by means of a digital signature or an asymmetric code. If the result of the identity verification is that the existence of the identity of the contacting network element, service server or charging server is not certain, the process P1 is terminated. In this case, access to the data managed by the central memory service is not permitted. Obviously, the execution of such an authentication procedure may also be omitted.

The function AR determines the extent to which access to the charging data records managed by the central memory service is permitted when the central memory service is contacted. For this purpose, the function AR first determines whether the central memory service is contacted by a network node or by a service server of the communications network TKN. It does this by verifying the identity of the contacting server, determined by the function AUT, in respect of whether this server is a network node or a service server of the telecommunications network TKN. If this is the case, the function AR permits charging data to be stored in charging data records managed by it.

The function AR furthermore determines whether the server contacting the central memory service is a charging server. For this purpose, the function AR verifies the identify of the contacting server, determined by the function AUT, in respect of whether the contacting server is a charging server. In this case, the function AR advantageously has access to a list of servers which are accepted by the function AR as charging servers. Each charging server which is to be accepted as a charging server by the function AR must be entered in this list. If the function AR determines that a server contacting the central memory service is an (accepted) charging server, it permits data to be read out from the charging data records managed by the central memory service.

It is also possible for the function AR to verify whether the network element or service server contacting the central memory service is identified as authorized in an access profile. Only in this case does the function AR permit charging data to be stored in a charging data record managed by it. For example, there is stored in memory, for each of the network elements of the communications network TKN and for each of the service servers of the communications network TKN, an access profile to which the function AR has access. It is also possible for such an access profile to be respectively stored in memory for a group of network elements of the communications network TKN or a group of service servers of the communications network TKN. This access profile describes the respective access rights of the assigned network element or of the assigned service server to the charging data records managed by the central memory service. These access rights can depend on a multiplicity of parameters. For example, parameters can be part of the service, user or time. Charging servers can also be assigned to such access profiles. These access profiles are then verified in the same manner by the function AR before it permits data to be read out from charging data records managed by it. It is also possible in this case for charging servers to be permitted, by means of the access profile, to write charging data into charging data records managed by the central memory service or to delete charging data from charging data records managed by the central memory service. In this way it is possible to define in detail which charging server may or may not see which charging data.

The function CCACC reads out data from charging data records managed by the central memory service and stores charging data in charging data records which are managed by the central memory service. If the central memory service is contacted by a network node or service server for the storage of charging data generated by this network node or service server and if the function AR permits the storage of this charging data, the function CCACC stores this charging data in that record of the charging data records, managed by the central memory service, that is assigned to the user to whom this charging data relates. If the central memory service is contacted by a charging server for access to charging data of a user of the communications network TKN and if the function AR permits this charging data to be read out from a charging data record managed by it, the function enables the charging server to read out this data from the charging data record of that user. This is realized, for example, in that the function reads out from memory unit DB charging data which is specified to the central memory service by the charging server and transmits it in a response to the charging server. When the function CCACC has been performed, or if the function AR determines that it does not permit a contacting server either to write or read data, the process P1 is terminated.

The control unit CONTR1 generates charging data and, for the purpose of storing this generated charging data, contacts the central memory services provided by the control unit CONTR2 by directing to the central memory service, via the communications medium KM, the service request SR with the parameters CHDAT, UID, SID and ACC. The parameter CHADAT in this case contains the charging data to be stored. The parameter UID specifies the sender of the service request, i.e., the control unit CONTR1. The parameter SID specifies the central memory service provided by the control unit CONTR2. The parameter ACC specifies the access type. Upon receipt of the service request SR, the function PC generates the process P1. From the parameter UID, the function AUT determines the identity of the contacting server, i.e., the network element NE1. The function AR determines that the network element NE1 is a network element of the communications network TKN and permits the charging data to be stored in the charging data records managed by the central memory service. The function CCACC determines, from the parameters CHDAT and ACC, that the charging data CHDAT is to be stored in one of the charging data records managed by the central memory service and to which user of the communications network KN this charging data is assigned. According to the thus determined information, the function CCACC introduces the charging data CHDAT into the data structure of the memory unit DB.

In parallel to the contacting of the central memory service, it is also possible for the control unit CONTR1 to store the charging data likewise in the memory unit LOG. Such a procedure is advantageous in respect of security. In the event of a malfunction of the server BSERV, it is thus still possible for the charging data to be retrospectively reconstructed.

In a manner similar to the control unit CONTR1, the application A2 contacts the central memory service by means of the service request SR. As a response to the service request SR, it receives the charging data CHDAT from the function CCACC.

It is advantageous in this case for the control unit CONTR2 to provide network elements, service servers and charging servers with a uniform access interface to the memory services provided by it. This is possible, for example, in that the memory service is to be contacted in the same manner by network elements, service servers and charging servers. For example, the service requests used for contacting the memory service have this data structure. It is also possible, however, for the control unit CONTR2 to make available different access possibilities to the memory service provided by it. On the one hand, different communication protocols can be used for different service servers, charging servers and network elements. On the other hand, the data structure of the service requests from different network elements, service servers and charging servers can differ. This may be advantageous in order to integrate already existing systems of different types.

1. Method for supporting the charging of services in a communications network, charging data relating to the charging of a service used by a user of the communications network being generated in the method by a network element or a service server of the communications network, wherein, for the purpose of storing the generated charging data, the network element or the service server contacts a central memory service for several network elements and/or service servers, wherein the central memory service stores the charging data in a charging data record, managed by it, which is assigned to the user of the communications network and is suitable for containing charging data relating to the use of two or more different types of services, and wherein, for the purpose of accessing charging data of the user, a charging server contacts the central memory service which then enables the charging server to read out data from the charging data record of the user managed by the central memory service.

2. Method according to claim 1, wherein the network element or the service server contacts the central memory service immediately following generation of the charging data for the purpose of storing the charging data.

3. Method according to claim 1, wherein the contacted central memory service manages a charging data record in which the charging data of all services of the communications network used by the user are centrally stored.

4. Server for supporting the charging of services in a communications network, with a control unit and with interfaces for connecting to network elements and/or service servers of the communications network, wherein the control unit is designed in such a way that it provides for several network elements and/or service servers a central memory service which manages charging data records of a multiplicity of users of the communications network which are respectively suitable for containing the charging data relating to the use of two or more different types of services of the communications network, wherein the control unit is further designed in such a way that, when the central memory service is contacted by a network element or a service server of the communications network for the storage of charging data generated by this network element or service server and relating to the charging of a service used by a user of the communications network, it stores the charging data in that record of the charging data records which is assigned to that user, and wherein the control unit is further designed in such a way that, when the central memory service is contacted by a charging server for access to charging data of the user, it enables the charging server to read out data from the charging data record of that user.

5. Server according to claim 4, wherein the control unit is further designed in such a way that, when the central memory service is contacted, it determines the identity of the network element, service server or charging server contacting the central memory service.

6. Server according to claim 4, wherein the control unit is further designed in such a way that, when the central memory service is contacted, it verifies, by means of an authentication procedure, the identity of the network element, service server or charging server contacting the central memory service.

7. Server according to claim 4, wherein the control unit is further designed in such a way that it verifies whether the contacting network element or the contacting service server is identified as authorized in an access profile and, in this case only, stores the charging data in a charging data record managed by it.

8. Server according to claim 4, wherein the control unit is further designed in such a way that it verifies whether the contacting charging server is identified as authorized in an access profile and, in this case only, enables data to be read out from the charging data record managed by it.

9. Server according to claim 4, wherein the control unit is further designed in such a way that it coordinates the accesses to the charging data records.

10. Server according to claim 4, wherein the control unit is further designed in such a way that it provides network elements, service servers and charging servers with a uniform access interface to the memory service.

11. Computer program for supporting the charging of services in a communications network, wherein the computer program is designed in such a way that, in its execution on a system platform, it provides for several network elements and/or service servers a central memory service which manages charging data records of a multiplicity of users of the communications network which are respectively suitable for containing the charging data relating to the use of two or more different types of services of the communications network, wherein the provided central memory service, when it is contacted by a network element or a service server of the communications network for the storage of charging data generated by this network element or service server and relating to the charging of a service used by a user of the communications network, stores the charging data in that record of the charging data records which is assigned to that user, and wherein the provided central memory service, when it is contacted by a charging server for access to charging data of the user, enables the charging server to read out data from the charging data record of that user.

12. Storage medium on which a computer program according to claim 11 is stored.
